(19) United States
(12) Patent Application Publication
(10) Pub. No.: US 2015/0039286 A1
(43) Pub. Date: Feb. 5, 2015

(54) TERMINOLOGY VERIFICATION SYSTEMS AND METHODS FOR MACHINE TRANSLATION SERVICES FOR DOMAIN-SPECIFIC TEXTS

(71) Applicant: Xerox Corporation, Norwalk, CT (US)

(72) Inventors: Vassilina Nikoulina, Grenoble (FR); Marc Dymetman, Grenoble (FR)

(73) Assignee: Xerox Corporation, Norwalk, CT (US)

(21) Appl. No.: 13/955,315

(22) Filed: Jul. 31, 2013

(51) Int. Cl. G06F 17/28

(52) U.S. Cl. CPC G06F 17/289
USPC 704/2

(57) ABSTRACT

A system and method for automated validation of a translation provided by a generic machine translation engine comprises a generic machine translation (GMT) engine, a domain-specific multilingual terminology dictionary (DS) and a translation processor. The translation processor effects the first call to the GMT engine to obtain a first translation of an input text to a first translation text; a verification of a presence of a domain-specific terminology item in the first translation text; correctness assessment of the first translation text using the DS wherein upon an assessment of incorrect translation, a replacement of the domain-specific terminology item with a domain-specific translation text item from the DS.

The Government Agency providing funding for this application is the European Union under Contract Number 270999, program name Organic. Lingua.

### BACKGROUND

The presently disclosed embodiments are directed to machine translation services of a first language text to a second language text, and more particularly, to the translation of domain-specific terminology within a text with a generic machine translation service. By “domain-specific” is meant that the terminology is dedicated to a particular subject (e.g., agriculture), problem or representation domain.

There are a number of generic machine translation services available for a large number of language pairs, e.g., Google Translate™, Bing™, and the like. The services allow relatively easy textual translation so that a document library can be multilingual. Such services are beneficial to allow access to documents written in (for example) a lesser known or unpopular language such as Estonian to a broader public. A particular problem arises though when the translating is performed by applying a generic machine translation (GMT) service to domain-specific text in that the translations often produce wrong results, especially when the translating concerns the translation of domain-specific terminology. Such a translation can be incomprehensible or misleading.

### EXAMPLE

Source sentence in English: Consequently, farmers tend to implement a broad non-focused weed-control strategy, on the basis of broad spectrum products and mixtures of different products.

Spanish Google translation: En consecuencia, los agricultores tienden a aplicar una amplia y no centrada en la estrategia de control de malezas, sobre la base de productos de amplio espectro y las mezclas o productos diferentes.

Spanish Bing translation: En consecuencia, los agricultores tienden a aplicar una estrategia amplia para control de malezas no centrado, sobre la base de productos de amplio espectro y las mezclas de diferentes productos.

Domain-adapted translation model: Por consiguiente, los agricultores tienen tendencia a no aplicar una amplia estrategia centrada control de malas hierbas, sobre la base de amplio espectro productos y mezclas de productos diferentes.

Correct terminology translation: weed-control=control de malas hierbas.

A known resolution to realize correct terminology translation is to train a domain-adapted translation model system on its own for the particular languages involved. However, such a training requires both significant expertise in a statistical machine translation (“SMT”) and an important amount of both in-domain and generic parallel texts, which is often not easily feasible, especially for low-resourced languages like Turkish or Estonian. Thus, there is a need for a correctly translating system where the content provider is not willing to train a dedicated translation system, either for reasons such as lack of technical skills or lack of parallel data. However, where a content provider has at its disposal a multilingual in-domain terminology dictionary that can be helpful for improving a generic translation provided by a service, the foregoing problems could be overcome. Such a service would perform multilingual terminology verification/correction services which not only detect wrongly translated terms, but also suggests a better translation of those terms.

More particularly, there is a need for a system that with mere access to a bilingual domain-specific technology dictionary the translation provided by a GMT service can be improved. Such a system and method would verify whether the terminology is domain-specific, and whether the translation was translated correctly by the GMT service, and if not, would locate the wrong translation of the term and suggest a better alternative translation of the term. Such a system and procedure would function as an aid for machine translation post-editing focused on in-domain terminology.

### SUMMARY

Methods and systems are provided for multilingual translation including a domain-adapted verification/correction service. The method includes first translating a first language item (e.g., a source sentence “s” including domain-specific terminology) to a corresponding second language item (e.g., a translated sentence “MT(s)” with a GMT service. The terminological correctness of the translation in the second language item is verified by accessing a domain-specific bilingual terminological dictionary (“DS”). Each term in the DS is checked to see if its source part (Ts) is in the first language item s. If the first language item includes the source part Ts, then the corresponding target part (Tt) of Ts from the DS is checked to see if it is in the second language item. If yes, and the number of occurrences of Ts in s is equal to the number of Tt in MT(s), then the translation is deemed to be consistent with the terminological base of the subject domain-specific terminology. If an inconsistency is identified between the second language item MT(s) and the translation Tt of the selected term Ts by the dictionary, the GMT service is then re-accessed for translating the Ts. The GMT translation of the selected term Ts is then used to locate the position of the inconsistent term translation in the second language item and to replace the inconsistent term translation by the correct term translation Tt.

In accordance with the subject embodiments, a system for automated validation of a translation provided by a generic machine translation (GMT) service engine comprises a GMT engine, a domain-specific multilingual terminology dictionary (DS) and a translation processor. The processor effects (1) a first call to the GMT engine to obtain a first translation of an input text to a first translation text; (2) a verification of a presence of a domain-specific terminology item in the input text; (3) a correctness assessment of the domain-specific term translation using the DS; (4) location of incorrect term translation via a second call to the GMT engine to obtain a translation of the domain-specific term found in input text, and matching the obtained term translation with the first translation text (5) suggesting a replacement of the incorrect domain-specific term translation with a correct domain-specific translation text item from the DS.

### BRIEF DESCRIPTION OF THE DRAWINGS

FIG. 1 is block diagram/flowchart of steps implemented by a processor to achieve the subject terminology verification embodiments; and,

FIG. 2 is a flowchart of steps to assess a correctness of a translation suggested by the subject terminology verification embodiments.

### DETAILED DESCRIPTION

The subject embodiments are directed to systems for locating an incorrect term translation in the GMT using the same GMT model for doing both the translation and the location of incorrect term translations. The incorrect term translation, once it is located, can either be directly replaced with a correct term translation (coming from a terminology dictionary), or can simply be suggested to a user as a potential replacement. In both cases a user needs to know the location of the wrong translation and it is so indicated to the user by the system. More particularly, when the GMT translates domain-specific terminology incorrectly, usually because it is not necessarily adapted to the domain and has no knowledge of what is the actual domain of the input text, and thus does not know a correct term translation, the subject systems perform additional verification for terms that are important for the subject domain, via a domain-specific terminology dictionary. By accessing such a domain-specific terminology dictionary, the GMT will be able to suggest a better translation.

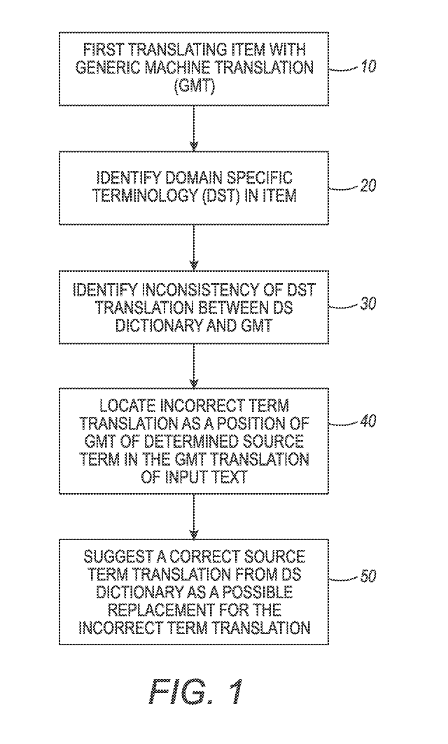

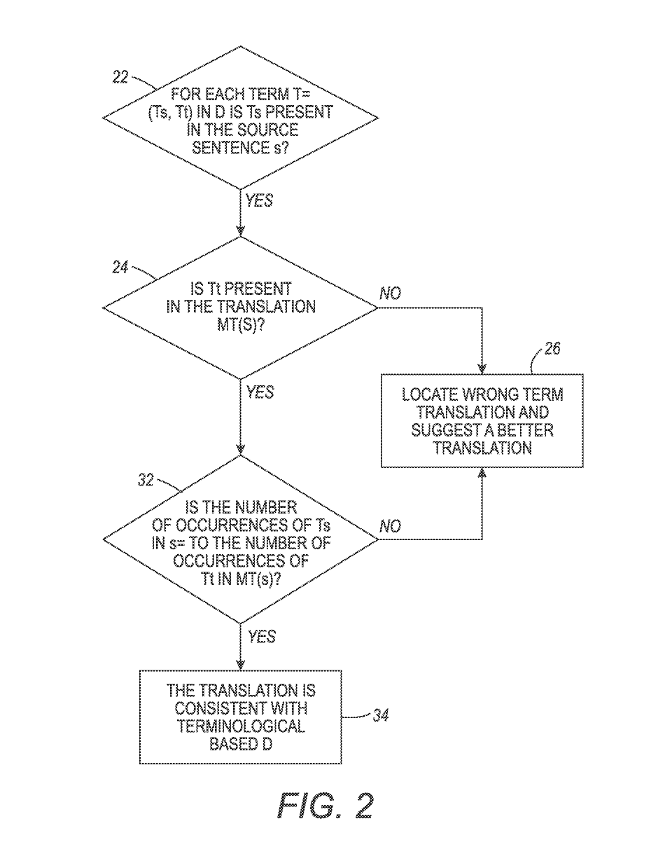

With reference to FIGS. 1 and 2, preferred embodiments are shown.

The subject embodiments comprise systems and methods utilizing a GMT engine, which is applied to translate a source sentence s in combination with an available domain-specific multilingual terminology dictionary (“DS” or “D”). The basic terminology verification procedure that is applied to the sentence s and to its translation MT(s) is done through the following steps:

1. For each term T=(Ts, Tt) in D check whether the source part Ts is present in the source sentence s. 22 [FIG. 2]

2. If s contains Ts, check whether the target part of the term Tt is present in the translation MT(s). 24
If yes, and the number of occurrences of Ts in s is equal to that of Tt in MT(s) the term translation is consistent with the terminological base, 22 and the translation is deemed consistent 34.
Otherwise, the wrong term translation is located and a better translation to the user is suggested 26.

Each of these steps requires a sub-string matching algorithm which should be able to deal with term detection problems such as morphological variants, term graphical variants (e.g. “air flow” or “airflow”), non-contiguity (e.g. Term “Fonction de Cobb-Douglas” should be detected in the following context: “fonction de production de Cobb-Douglas”) etc. There already exist several approaches for these problems that rely on Part of Speech (PoS) tagging and lemmatization of terms for resource-rich languages, and/or Levenstein distance and Longest Common Subsequence algorithm for resource poor languages.

Once it is detected that there is a source term Ts which has been incorrectly translated, a better translation for this term is suggested. This requires not only knowing a correct translation (Tt) of the term (Ts), but also its position in the target sentence (t(Ts)). In other words, one needs to identify what was the incorrect translation proposed by the MT engine and to locate its position in the translation MT(s).

This can be seen as a sub-problem of the word-alignment problem, which is usually solved using bilingual dictionaries or by learning statistical alignment models out of bilingual corpora. However, in practice, these resources are not easily available, especially for low-resourced language pairs (e.g., Turkish, Latvian).

In order to solve this problem of locating the wrong term translation in the target without resorting to such resources, the subject embodiments rely instead on the same external MT engine that was used for translating the whole source text in the first place. The hypothesis is that the translation of the isolated source term Ts with the same MT engine should enable one to locate the wrongly translated term t(Ts) in MT(s) in most of the cases.

The location of the wrong term translation t(Ts) can be done by directly matching MT(Ts) in the translation of the whole sentence (MT(s)), and choosing the best matching sub-string.

While this is likely to work reasonably well in many cases, it is however possible that the MT engine translation of an isolated term will be different from its translation of the same term in context. This is especially true for statistical models where the word order and surrounding tokens may influence the choice of the best translation due to the influence of the target language model. In such cases one may consider not only the translation of the term itself, but different variants of it:

1. translation of term out-of-context : MT(Ts);

2. translation of context-extended term; e.g., if s =s1 . . . sN , the context-extended term is si-n Ts sj+n , where Ts =Si . . . 4; thus, one relies on the match between the translation MT(si-n Ts sj+n) to locate t(Ts) in MT(s);

3. translation of the left and/or right context (possibly restricted to n-gram): MT(si-n . . . si-1), MT(sj+1 . . . sj+n); this variant may allow to locate the limits of the wrong term translation;

4. re-translation of the whole sentence with the term excluded (or replaced by a non-translatable place-holder).

In theory, none of the above options can guarantee a perfect term location in the case of SMT, which can produce unexpected results when the context has been changed, or when unknown words (place-holders) have been artificially introduced (the unknown tokens might be heavily penalized by Language Model (LM) at the decoding stage which may lead to a very different translation).

These variants can be combined in multiple ways in the final framework for wrong term translation location:
sequentially: if the wrong term translation was not located after the first step (out-of-context translation), attempt the following step, until the term is located;
considering all translation options simultaneously:
   each option suggests a possible term location; the best location can be chosen via choosing a term location suggested by the majority (of the 4 variants for term location described above);
   find possible wrong term translation locations with each of the variants, assign a confidence score to each of them, and choose the most confident one.

With particular reference to FIG. 1, the foregoing steps are seen grammatically wherein the system processor (not shown) first translates 10 an input text item with a generic machine translation (GMT). The processor then identifies 20 whether any domain-specific terminology (DST) is present in the input text. The correctness is verified by assessing whether the target part of the so determined source term is present in the generic machine translation of the input text. Such checking can identify 30 whether there was an inconsistency in the domain-specific terminology translation between a domain-specific dictionary translation and the GMT. Upon detection of the inconsistency, an incorrect term translation is located as a position of generic machine translation of the determined source term (possibly extended with its context) in the generic machine translation of input text 40. A correct source term translation is suggested 50 from the domain-specific terminology dictionary, as a possible replacement of the incorrect term translation located in 40.

FIG. 2, as discussed above, then assesses the correctness of the translation by counting the number of occurrences of the domain-specific target term translation in the generic machine translation of the input text.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

What is claimed is:

1. A method of multilingual translation including a domain-adapted verification/correction service, including:
first translating a first language item including domain-specific terminology to a corresponding second language item with a generic machine translation service;
identifying an inconsistency of terminology translation in the second language item relative to the first language item by accessing a domain-specific multilingual terminology dictionary including the domain-specific terminology;
if the inconsistency is identified between a selected terminology in the second language item and a translating of the selected terminology by the terminology dictionary, accessing the generic machine translation service for a second translating of a part of the first language item including the selected terminology and replacing the selected terminology in the second language item with a terminology translation of the selected terminology from the terminology dictionary.

2. The method of claim 1 wherein for the selected terminology comprises a source term in the first language item and a corresponding translation term in the second language item, and the identifying comprises identifying if the source term or the translated term is included in the domain-specific multilingual terminology dictionary.

3. The method of claim 2 wherein the identifying comprises checking if a source part of the translated term is present in the first language item.

4. The method of claim 3 wherein the first language item comprises a source sentence and the checking includes confirming a presence of the source part in the source sentence.

5. The method of claim 4 wherein upon the confirming of the presence of the source part in the source sentence, second checking if a target part of the translated term has a presence in the second language item.

6. The method of claim 5 wherein upon the second checking confirming the presence of the target part in the second language item, the method further includes first counting a number of occurrences of the source part in the source sentence, and second counting a number of occurrences of the target part in the corresponding second language item, and if the first counting and the second counting are equal in number, accepting the corresponding second language item as a proper and consistent translation relative to a terminological base of the terminology dictionary.

7. The method of claim 5 wherein upon the second checking confirming the presence of the target part in the second language item, the method further includes first counting a number of occurrences of the source part in the source sentence, and second counting a number of occurrences of the target part in the corresponding second language item, and if the first counting and the second counting are different in number, locating a wrong translation in the corresponding second language item, and suggesting an alternative translation.

8. The method of claim 7 wherein the locating the wrong translation includes identifying a relative position of the wrong translation in the corresponding second language item.

9. A system for automated validation of a translation provided by a GMT engine, comprising:
a GMT engine;
a domain-specific multilingual terminology dictionary (DS);
a translation processor for effecting:
a first call to the GMT engine to obtain a first translation of an input text to a first translation text;
a verification of a presence of a domain-specific terminology item in the first translation text;
a correctness assessment of the first translation text using the DS;
upon an assessment of an incorrect translation, a second call to the GMT engine to obtain a second translation text of the domain-specific terminology; and,
a replacement of the second translation text with a domain-specific translation text item from the DS.

10. The system of claim 9 wherein the processor further effects a second assessment of the first translation text comprising a counting of occurrences of source and translation parts corresponding to the domain-specific translation text item in the input text and the first translation text.

11. The system of claim 10 wherein upon the counting determining a matching number of source and translation parts, the translation is deemed accurate.

12. The system of claim 10 wherein upon the counting determining a different number of source and translation parts, a wrong term translation is located in the first translation text, and an alternative translation is suggested.

13. The system of claim 12 wherein the processor further includes effecting a further call to the GMT and matching the domain-specific terminology item in the first translation text.

14. The system of claim 12 wherein the processor further includes assessment of a plurality of variants of translation of the domain-specific terminology item in the first translation text comprising:
sequentially: if the wrong term translation was not located after the first step (out-of-context translation), attempt the following step, until the term is located;
considering all translation options simultaneously:
each option suggests a possible term location; the best location can be chosen via voting;
find possible wrong term translation locations with each of the variants, assign a confidence score to each of them, and choose the most confident one.
